(19) United States
(12) Patent Application Publication
(10) Pub. No.: US 2004/0087883 A1
(43) Pub. Date: May 6, 2004

(54) Pedicure foot bath

(76) Inventor: William H. Berger, Arcadia, CA (US)

Correspondence Address: Ruth Eure, 4795 Edison Avenue, Boulder, CO, 80301, US

(21) Appl. No.: 10/674,251

(22) Filed: Sep. 29, 2003

Related U.S. Application Data
(60) Provisional application No. 60/423,195, filed on Oct. 31, 2002.

(51) Int. Cl. A61H 33/00

(52) U.S. Cl. 601/167; 601/17; 607/86; 601/158

(57) ABSTRACT

A pedicure foot bath is provided having a removable water moving module. The water moving module of the present invention comprises a rotating paddle which simulates an ocean-like wave motion which soothes and relaxes sore, tired and injured feet.

### PRIORITY CLAIM

The inventor of this application claims priority from U.S. Provisional Patent Application Serial No. 60/423,195, filed Oct. 31, 2002, entitled “Footbath”.

### FIELD OF THE INVENTION

This invention relates to the field of physical therapy devices, and more specifically to the field of hydrotherapy devices such as foot baths.

### BACKGROUND OF THE INVENTION

It has long been known that soaking the feet offers significant therapeutic benefit to anyone suffering from injured or sore feet. Soaking the feet can help to reduce pain due to injury, over-exercise or ill-fitting shoes. It has also been discovered that moving water can stimulate circulation by creating a hydrotherapeutic effect. This can be of great benefit not only to those with ordinary foot pain, but also to anyone suffering from peripheral neuropathy due to illness such as diabetes, or any other condition such as those which may impair blood circulation. Many methods of creating a hydrotherapeutic effect have been put forth.

For example, U.S. Pat. No. 4,620,529 to Kurosawa recites a foot bath having a vibrating mechanism for stimulating and massaging the user's feet, and U.S. Pat. No. 4,497,313, also to Kurosawa additionally teaches heating the water.

Pulsating water also creates a beneficial therapeutic massaging effect. For example, both U.S. Pat. Nos. 6,178,570, and 5,810,257 describe a spa jet having a rotating nozzle to create a pulsating water flow.

Another example is found in U.S. Pat. No. 6,009,574 which describes a hydrotherapy bath including a water turbine requiring pressurized water, as from a tap, and additional air jets for creating a pulsed water massage.

In contrast, the present invention puts forth the novel idea of a rotating paddle wheel for selectively permitting water to flow through an opening to produce a wave motion to the water. The wave motion thus created mimics the movement of waves in the ocean. This ocean wave motion generating apparatus is novel to the present invention in view of these prior art devices. The present invention requires no pressurized water source, nor any additional air jets to create its therapeutically beneficial movement of water. The wave motion generated by the water moving apparatus of the foot bath of the present invention is more gentle and soothing than a jet stream of water propelled by air.

### SUMMARY OF THE INVENTION

The present invention provides a foot bath which provides a beneficial therapeutic massage to the feet having a water moving apparatus which simulates an ocean-like wave motion which soothes and relaxes sore, tired, and injured feet.

The ocean-like wave motion is designed to provide a massaging action to the feet and is based on physiological principles which are known to improve circulation and return blood back to the heart. The massaging action provided by the instant invention also relieves fatigue, tones muscles, relieves soreness and reduces swelling.

It is an object of the present invention to provide a foot bath having a removable water moving module. This is of value because one module can be moved from a prior used unclean foot bath to a clean foot bath in a sequential manner so as to accommodate multiple clients or patients without loss of time while waiting for the initial foot bath to be cleaned and refilled. This is of additional value because if, for some reason, one foot bath becomes unusable, the water moving module can still be utilized, or vice versa, if the water moving module becomes unusable, the foot bath can still be used.

It is also an object of the present invention to provide a foot bath which is portable and easy to transport. This can be of benefit, not only for convenience, but also to reduce injury. The foot bath can be brought to the site of an injury, thereby reducing the likelihood of re-injury or exacerbating the original injury.

It is an additional object of the present invention to provide a hydrotherapy foot bath having multiple water flow patterns easily controlled by the user.

It is an additional object of the present invention to provide a hydrotherapy foot bath having a heating element to provide warm water in addition to all of the above-mentioned features.

These and other objects will become apparent to the person of ordinary skill in the art in reading the following detailed description taken in conjunction with the accompanying drawings.

### BRIEF DESCRIPTION OF THE DRAWINGS

FIG. 2 is a top view of the foot bath of the present invention.

FIG. 3 is a longitudinal cross-sectional view of the foot bath of the present invention, showing the chamber which houses the removable water moving module, with the water moving module in place in the foot bath.

FIG. 3A shows the same longitudinal view of the removable water moving module with the water moving module removed from the foot bath.

FIG. 4 is a top view of the foot bath of the present invention showing the removable water moving module in phantom.

FIG. 5 is a top view of the removable water moving module of the present invention in more detail showing the longitudinal cross-sectional view taken along plane A-A.

FIG. 6 is cross-sectional view taken along plane A-A showing plane B-B.

FIG. 7 is a top view of the removable water moving module taken along plane B-B.

FIG. 8 is a side view of the foot bath of the present invention showing the alignment pin used to secure the water moving module in the foot bath.

FIG. 9 is a top view of the foot bath of the present invention showing the placement of the alignment pin in the module area.

### DETAILED DESCRIPTION

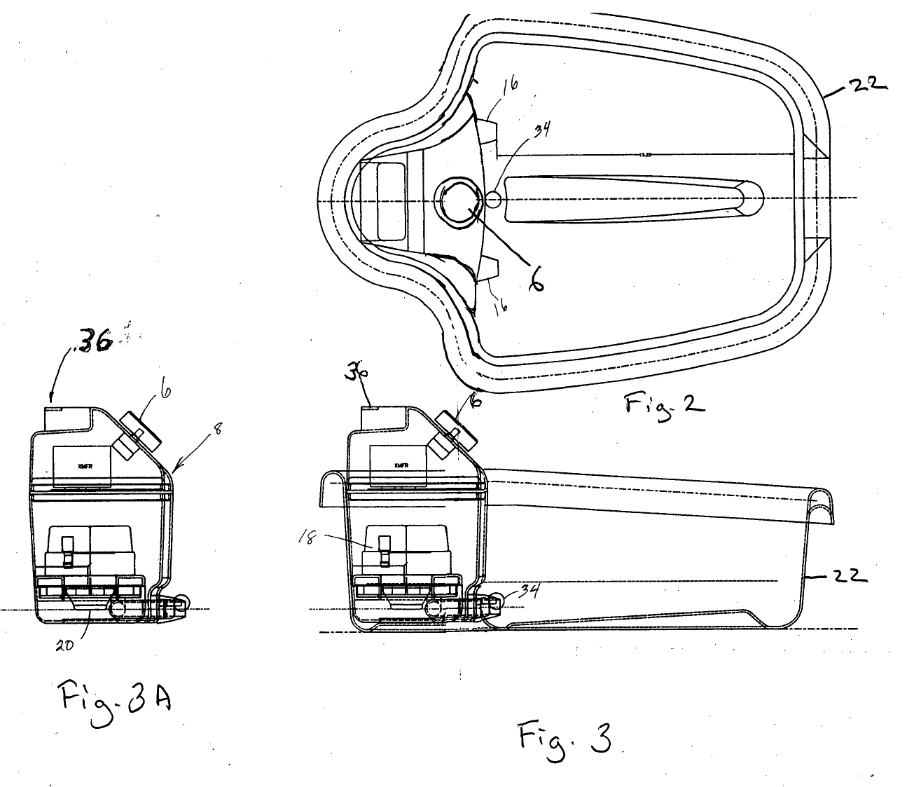

FIG. 2 is a top view of the foot bath of the present invention.

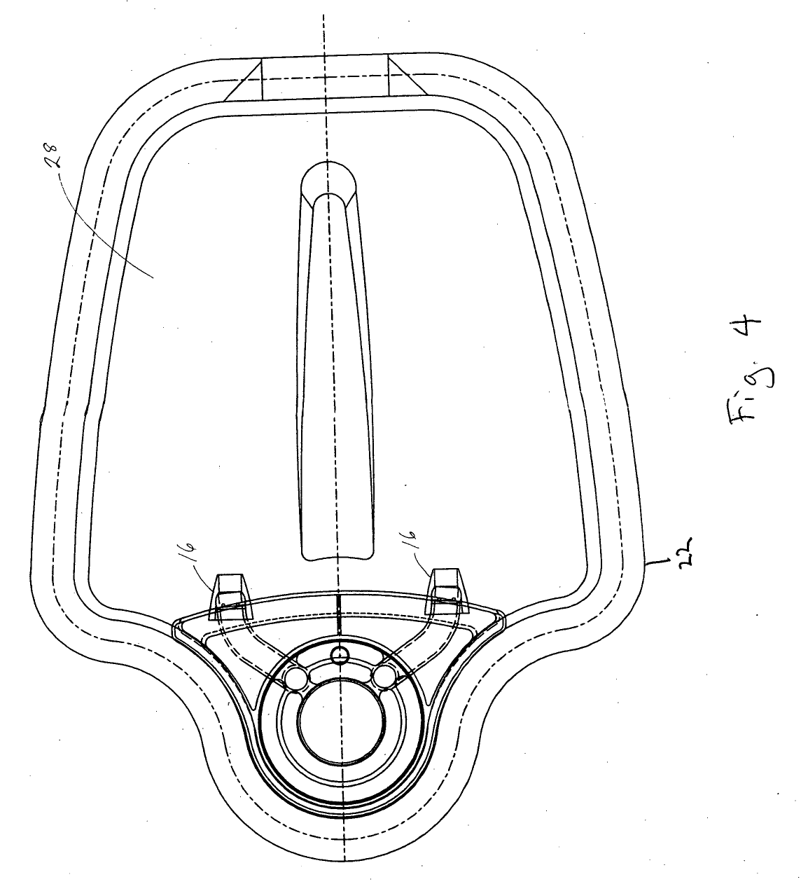

FIG. 3 is a side view showing the removable water moving module 8 in place in the foot bath secured by alignment pin 10. FIG. 3A shows the removable water moving module removed from the foot bath. FIGS. 3 and 3A also show the speed control knob 6 for controlling the flow of the water. The water moving module 8 is also equipped with a handle 36 to lift the module out of the foot bath. Handle 36 expedites the removal of the module from one bath for easy and quick insertion into another foot bath. The water moving module can also comprise a heating element to provide warm water over an extended period of time preventing the water from cooling during use.

The foot bath of the present invention comprises an outer chamber 22 made of any suitable water retaining material such as plastic sized to accommodate the removable water moving apparatus, approximately 2 to 3 gallons of water and a pair of human feet. These dimensions are variable, but one design may typically measure approximately 22 inches long, by 17 inches wide, by 7 inches deep. The outer chamber 22 is clearly shown in FIGS. 2, 3, and 4.

Turning to FIG. 3, outer chamber 22 comprises a module area 24 for receiving the removable water moving module 8. Module area 24 is a recessed section in the front portion of the chamber 22 for receiving water moving module 8. Water moving module 8 comprises a submersible pump and two nozzles 16 which extend into the bath section 28.

Many submersible pumps are suitable for use in the water moving module of the present invention. For example, one suitable pump is a 12 volt DC pump capable of pumping 800 gallons per hour at 5 psi maximum. One such pump is Rule Pump model 20F from ITT Industries, headquartered in White Plains, N.Y.

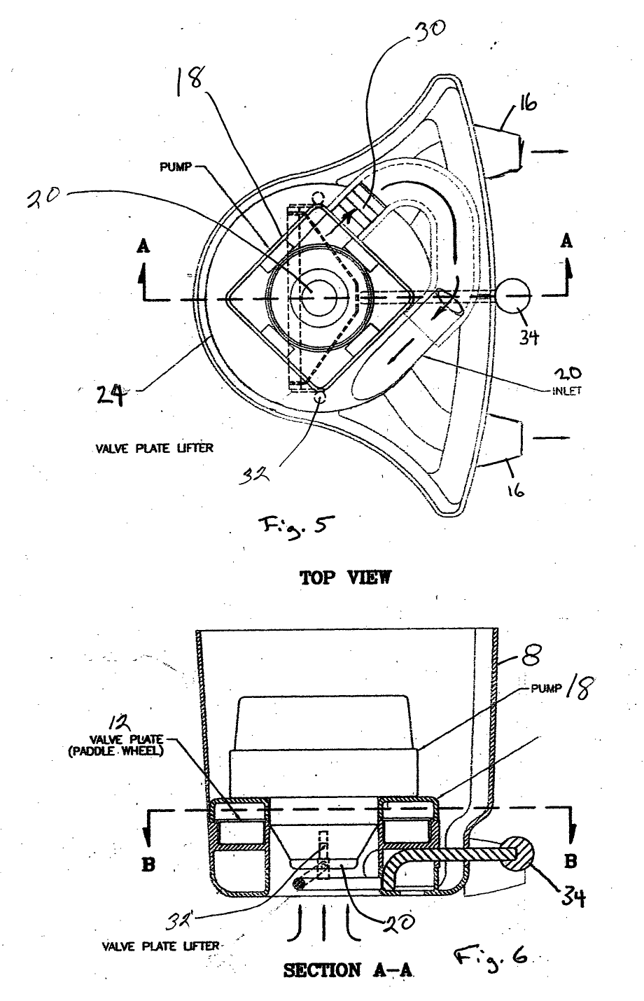

Please refer to FIGS. 4 through 7. Submersible pump 18 is equipped with intake port 20 which receives the water. The water exits the pump through outlet port 30. Water exiting outlet port 30 drives paddle wheel 12 by pushing on vanes 32. Paddle wheel 12 comprises two essentially parallel circular disc sides and a plurality of vanes 32 radially dispersed between the two circular disc sides perpendicular to the flow of the water exiting the outlet port 30. Although a perpendicular arrangement is described, an angular arrangement other than perpendicular also would be operable. The force of the water hitting vanes 32 causes paddle wheel 12 to rotate. The rotation of paddle wheel 12 creates a pulsating effect due to openings 14 situated on the circular disc bottom portion of the paddle wheel 12 perpendicular to the vanes. The bottom surface of paddle wheel 12 which has openings 14 comprise valve plate 26. When the paddle wheel 12 rotates, openings 14 on valve plate 26 also rotate and allow water to flow through the openings intermittently. The intermittent flow of water creates the pulsating effect. The openings in the paddle wheel effectively create a rotary slide valve, which oscillates the flow of water through nozzles 16 by interrupting the flow of water, thus creating an ocean-like wave motion in the water in the bath section. This oscillation of water is created when the openings allow water to flow intermittently into the nozzles 16.

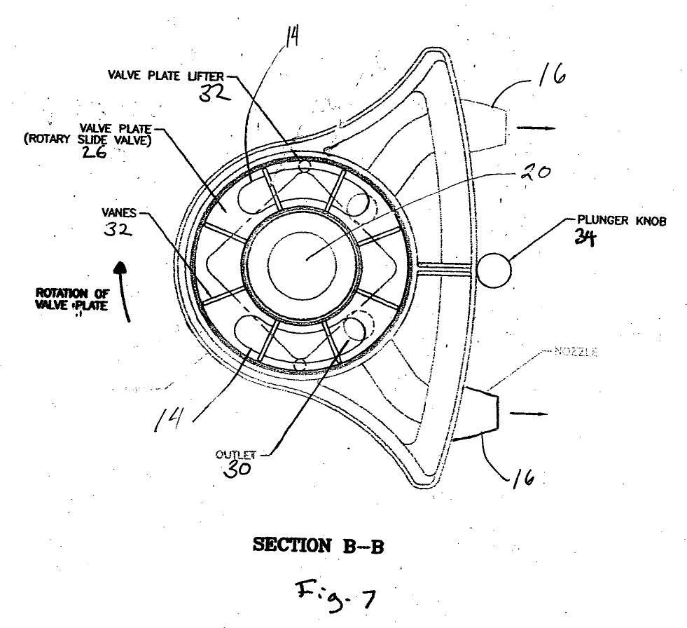

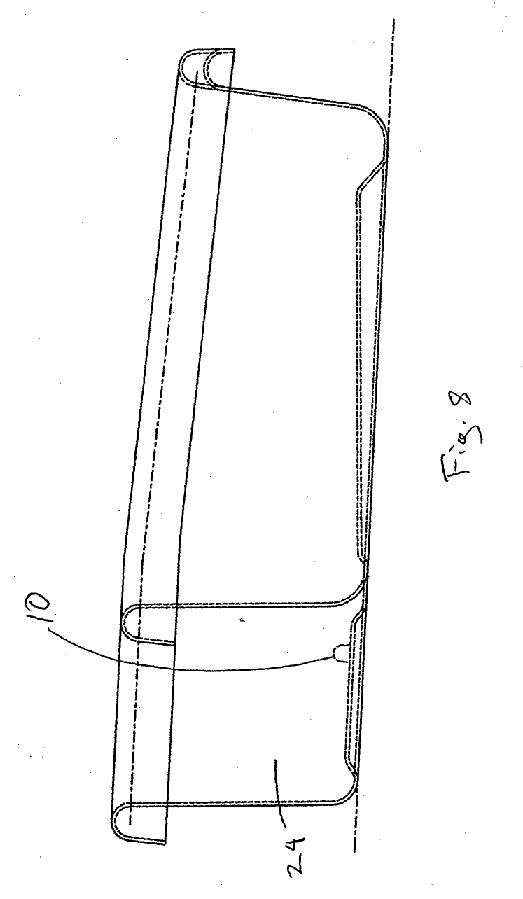

FIGS. 6 and 7 show the operation of plunger knob 34. Plunger knob 34 controls the flow of water to the nozzles. When plunger knob 34 is pulled outward, toward the user, valve plate lifter 32 is raised, thus lifting the paddle wheel 12 permitting a steady flow of water to the nozzles. When plunger knob 34 is pushed in, it lowers paddle wheel 12, allowing the water to rotate paddle wheel 12 resulting in the pulsating flow of water to nozzles 16 to create the ocean-like wave motion novel to the present invention.

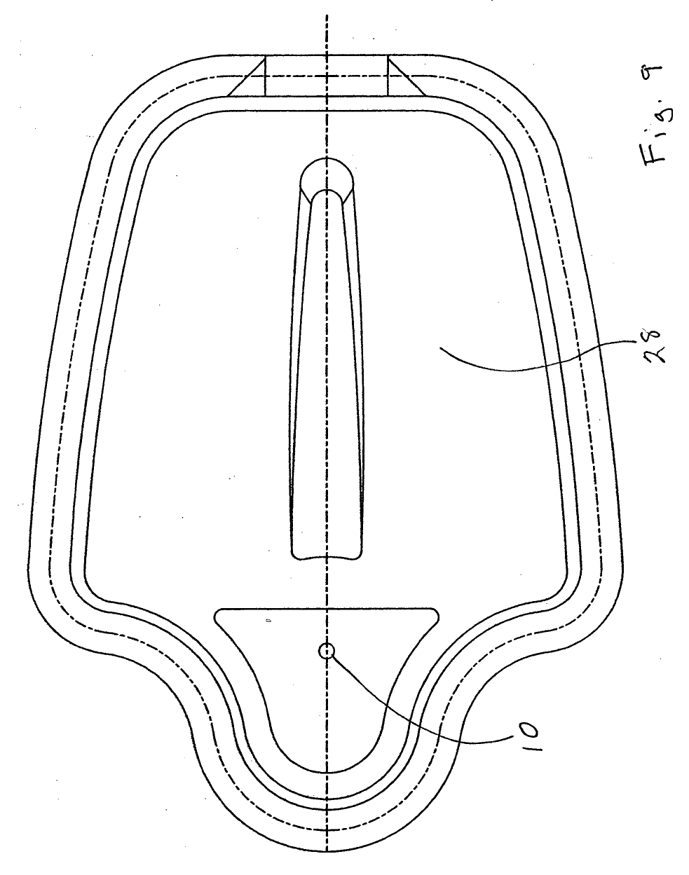

Removable water moving module 8 can be easily removed from module area 24 by simply lifting the module using handle 36. To permit easy and secure insertion of module 8 into module area 24, an upwardly projecting alignment pin 10 on the bottom of area 24 near the center of area 24 mates with a female recession in the module 8 which is designed for this purpose. This serves to securely hold module 8 in place in module area 24. Alignment pin 10 can be clearly shown in FIGS. 8 and 9.

In operation, the foot bath of the present invention is filled with water from an outside source. This allows the addition of therapeutic agents such as Epsom salts or skin softeners to be added. The user can control the flow rate of the water by adjusting the speed control knob. The user can also adjust the intensity of the pulsating massaging effect by controlling the plunger knob. When a patient or client is finished with the foot bath, the removable water moving module can be removed easily by the handle and placed in another foot bath for a second user. The first foot bath can then be easily cleaned and readied for the next user.

No other foot bath of the prior art taken singly or in. combination supplies all of the features of the present invention. The pulsating ocean-wave motion massage effect of the present invention is not found anywhere in the art and is unique to the present invention.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A water moving apparatus comprising:
a) a submersible pump having an intake port for receiving water and an outlet port;
b) a paddle wheel comprising a plurality of vanes positioned such that water exiting the outlet port hitting the vanes causes the paddle wheel to rotate; and
c) at least one opening on the paddle wheel to allow intermittent flow of water through the opening when the paddle wheel rotates.

2. The water moving apparatus of claim 1, wherein the paddle wheel comprises two essentially parallel circular disc sides.

3. The water moving apparatus of claim 2, wherein the vanes are radially dispersed between the two essentially parallel circular disc sides.

4. The water moving apparatus of claim 1, wherein the vanes are perpendicular to the flow of water exiting the outlet port.

5. The water moving apparatus of claim 3 wherein the vanes are perpendicular to flow of water exiting the outlet port.

6. The water moving apparatus of claim 1 wherein the water moving apparatus is positionable in a pedicure foot bath.

7. The water moving apparatus of claim 1 further comprising a means for heating water.

8. The water moving apparatus of claim 2 further comprising a plunger knob movable in a first direction to lift the paddle wheel, and movable in a second direction to lower the paddle wheel.

9. The water moving apparatus of claim 8 wherein the first direction is pulling out the plunger knob and the second direction is pushing in the plunger knob.

10. The water moving apparatus of claim 1 further comprising a means for heating water.

11. The water moving apparatus of claim 1 wherein the water moving apparatus is removable from the pedicure foot bath.

12. The water moving apparatus of claim 6 further comprising at least one nozzle having an intake portion for receiving the intermittent flow of water from the openings in the paddle wheel and an outlet portion for directing the intermittent flow of water into the pedicure foot bath.

13. The water moving apparatus of claim 7 further comprising at least one nozzle having an intake portion for receiving the intermittent flow of water from the openings in the paddle wheel and an outlet portion for directing the intermittent flow of water into the pedicure foot bath.

14. The water moving apparatus of claim 1 wherein the opening on the paddle wheel is perpendicular to the vanes.

15. The water moving apparatus of claim 1 comprising a plurality of openings on the paddle wheel.

16. A method of generating a hydrotherapeutic effect comprising:
a) providing the apparatus of claim 1; wherein
b) water exiting the outlet port pushes on the vanes causing the paddle wheel to rotate;
c) rotation of the paddle wheel allows intermittent flow of water through the openings generating pulsating flow of water resulting in a hydrotherapeutic effect.
